(19) United States
(12) Patent Application Publication
(10) Pub. No.: US 2006/0091084 A1
(43) Pub. Date: May 4, 2006

(54) Fluted filter media with intermediate flow restriction and method of making same

(75) Inventors: Steven J. Merritt, Kearney, NE (US); Greg Driml, Kearney, NE (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6780, US

(73) Assignee: Baldwin Filters, Inc., Kearney, NE (US)

(21) Appl. No.: 10/979,453

(22) Filed: Nov. 2, 2004

(51) Int. Cl. B01D 29/07

(52) U.S. Cl. 210/767; 210/493.1; 55/521

(57) ABSTRACT

A fluted filter media includes a wall of porous filter material separating a first flute from one or more adjacent flutes, and an intermediate flow restriction disposed in the first flute between upstream and downstream ends of the filter media, so that fluid entering the first flute upstream of the intermediate flow restriction is urged to flow through the wall upstream of the intermediate flow restriction into one or more of the one or more adjacent flutes while flowing through the filter media. Where the adjacent flutes include flow restrictions disposed upstream and downstream from the intermediate flow restriction, the intermediate flow restriction urges fluid flowing through the first flute to pass through the wall at least twice between the upstream and downstream ends of the media. Filter apparatuses and methods incorporating such a fluted filter media having an intermediate flow restriction are also provided.

### FIELD OF THE INVENTION

This invention relates to fluid filters for removing particulate matter from a flow of fluid in liquid or gaseous form, including filters of the type used for filtering inlet air supplied to machinery such as engines and compressors

### BACKGROUND OF THE INVENTION

Filters of the type used for filtering particulate matter from fluid sometimes include one or more layers of a porous filter material that is formed into a convoluted pattern, often referred to in the industry as fluted filter media. In such a fluted filter media, a sheet of the porous filter is typically formed into convolutions having peaks and valleys extending in a generally parallel and adjacent orientation to one another from an upstream end to a downstream end of the filter media. The valleys on one side of the convoluted sheet form a series of first flutes, joined by the peaks of the convolutions, and separated from one another by a series of adjacent flutes formed by the valleys on the reverse side of the sheet. The sheet of porous material forms a common wall between each of the first flutes and its adjacent flutes.

In one commonly used form of such a fluted filter media, the upstream ends of the first flutes are open and the downstream ends are blocked, while the upstream ends of the adjacent flutes are blocked and the downstream ends are left open. As a result of this arrangement, fluid can only enter the upstream ends of the first flutes, and fluid entering the upstream ends of the first flutes is forced to flow through the wall of porous material and into the adjacent flutes, in order to exit the filter media through the open downstream ends of the adjacent flutes. As the fluid flows through the wall of porous material from the first flutes to the adjacent flutes, particulate matter in the fluid is filtered out of the fluid and trapped in the first flutes and the porous filter material of the wall. United States patent application number US 2003/0121845 A1, to Wagner, et al, discloses such an approach.

It is desirable to provide an improved fluted filter media for removing particulate matter from a fluid more effectively and efficiently than prior fluid filters using fluted filter media of the type described above. It is also desirable to provide a method for making such an improved filter media. It is further desirable to provide an apparatus and method for using such an improved fluted filter media to remove particulate matter from a fluid.

### BRIEF SUMMARY OF THE INVENTION

The invention provides an improved apparatus and method for removing particulate matter from a fluid through use of a fluted filter media having an intermediate flow restriction disposed between an upstream end and a downstream end of the media.

In one form of the invention, a fluid media defines an upstream and a downstream end thereof, a first flute and one or more adjacent flutes extending from the upstream end to the downstream end of the filter media. The first and adjacent flutes include upstream and downstream ends of the first and adjacent flutes at the upstream and downstream ends respectively of the filter media. The filter media also includes a wall of porous filter material separating the first flute from the one or more adjacent flutes, and an intermediate flow restriction disposed in the first flute between the upstream and downstream ends of the filter media, so that fluid entering the first flute upstream of the intermediate flow restriction is urged to flow through the wall upstream of the intermediate flow restriction into one or more of the one or more adjacent flutes in order to flow from the upstream end to the downstream end of the filter media. The filter media further includes an upstream flow restriction and a downstream flow restriction, respectively disposed in the at least one adjacent flute upstream and downstream from the intermediate flow restriction, such that fluid entering the at least one adjacent flute from the first flute upstream of the intermediate flow restriction is urged to flow back through the wall, and into the first flute, downstream from the intermediate flow restriction.

The intermediate, upstream and downstream flow restrictions may be formed in such a manner that they completely block fluid flow through the flow restriction, or such that fluid flow through the flow restriction is only partially blocked.

The adjacent flutes may be blocked by the upstream and downstream flow restrictions proximate to both their upstream and downstream ends so that fluid cannot enter the upstream ends of the adjacent flutes, or exit from the downstream ends of the adjacent flutes, but must enter the adjacent flutes by flowing through the wall of porous material from the first flute and exit the adjacent flutes by flowing back through the wall of porous material into the first flute to exit the filter media through the downstream end of the first flute. By virtue of this arrangement, fluid passing through the filter media must pass through the wall of porous material at least twice, once upstream and once downstream from the intermediate flow restriction, in flowing from the upstream to the downstream ends of the filter media. This double-pass filtering results in improved efficiency and effectiveness of the filter media, in comparison to prior filter medias having alternate ends of adjoining first and adjacent flutes blocked, to thereby provide only a single pass through the wall of porous material by the fluid as it flows from the upstream to the downstream ends of the filter media.

A fluted filter media, according to the invention, may also include additional intermediate flow restrictions in the flutes to cause the fluid to make more than two passes through the wall of porous material as the fluid flows from the upstream end to the downstream end of the filter. The fluted filter media may also include selected sections of higher and lower porosity, and/or one or more openings, in the form of holes, slots, etc., extending through the wall for providing fluid communication through the wall between the first flute and one or more adjacent flutes. These higher and lower porosity sections and/or openings in the wall may be positioned and sized to provide a desired flow resistance for a flow of fluid passing through at least a portion of the first flute from the upstream end to the downstream end of the filter media.

The fluted filter media may include a convoluted sheet of material having peaks and valleys extending in a generally parallel and adjacent orientation to one another from the upstream to the downstream end of the filter media, with the convolutions at least partially defining the first flute, and at least one of the one or more adjacent flutes. In some forms of the invention, the intermediate flow restriction may be provided by applying a bead of sealant in the valleys of the convoluted sheet of material. The intermediate flow restriction may also take other shapes and be provided by other methods, such as locally deforming one or more peaks of the convoluted sheet.

The media may also include a face sheet attached to the convoluted sheet. Where the intermediate flow restriction is provided by deforming one of the peaks of a convoluted sheet, the locally deformed area of the peak may be bonded to a face sheet with an adhesive and/or sealant. The face sheet may be formed from a porous filter material, and may form part of the wall separating one or more first flutes from adjacent flutes in successive layers of a filter apparatus having more than one layer of a fluted filter media with an intermediate flow restriction, according to the invention. The porous material used for the face sheet may include sections of higher and lower porosity. The face sheet may alternatively be formed of a non-porous material, or a material that is porous in some areas of the face sheet and non-porous in others. The face sheet may also include openings, such as holes or slits, extending through the face sheet, in face sheets formed of either porous or non-porous material.

A filter apparatus, according to the invention, may take the form of one or more layers of a fluted filter media having one or more first flutes including an intermediate flow restriction disposed between an upstream end and a downstream end of the first flutes, and upstream and downstream flow restrictions disposed in the adjacent flutes at points respectively upstream and downstream from the intermediate flow restriction. The filter apparatus may comprise a filter cartridge, adapted for attachment to a filter assembly, but not including the filter assembly. Such a filter cartridge may comprise a coil of fluted filter media having one or more first flutes including an intermediate flow restriction disposed between an upstream end and a downstream end of the first flutes, and upstream and downstream flow restrictions disposed in the adjacent flutes at points respectively upstream and downstream from the intermediate flow restriction.

A filter apparatus, according to the invention, may alternatively take the form of a filter assembly adapted for attachment thereto of a filter cartridge, and a filter cartridge including one or more layers of a fluted filter media having one or more first flutes including an intermediate flow restriction disposed between an upstream end and a downstream end of the first flutes, and upstream and downstream flow restrictions disposed in the adjacent flutes at points respectively upstream and downstream from the intermediate flow restriction. The filter cartridge, in such a filter apparatus, may comprise a coil of a fluted filter media having one or more first flutes including an intermediate flow restriction disposed between an upstream end and a downstream end of the first flutes, and upstream and downstream flow restrictions disposed in the adjacent flutes at points respectively upstream and downstream from the intermediate flow restriction.

In forms of the invention wherein the media includes a plurality of first flutes, each including an intermediate flow restriction therein, the intermediate flow restriction in one or more of the first flutes may disposed at a first distance from the upstream and/or downstream ends of the media, and the intermediate flow restriction in one or more of the other first flutes may be disposed at a second distance from the one of the upstream and/or downstream ends of the filter media. The intermediate flow restrictions in the first flutes may also be offset from one another at distances varying in a predetermined pattern with respect to one of the upstream or downstream ends of the media. For example, the intermediate flow restrictions may be applied in a manner forming geometric patterns such as an angled or stepped line, a saw tooth pattern, or a sinusoidal pattern along the length of the media. Such offset arrangements of the intermediate flow restrictions provide advantages in directing fluid flow both within a given layer of the media, and between successive layers of the media, in ways that are conducive to enhancing filtering efficiency, effectiveness, and contaminant holding capability, and to controlling pressure drop in the media.

The invention may also take the form of a method for forming or using a filter media, or a filter apparatus, according to the invention.

Other aspects, objectives and advantages of the invention will be apparent from the following detailed description and the accompanying drawings.

### BRIEF DESCRIPTION OF THE DRAWINGS

FIG. 1 is a perspective view of a first exemplary embodiment of the invention, in the form of a fluted filter media having a plurality of first flutes including an intermediate flow restriction disposed between an upstream end and a downstream end of the first flutes.

FIG. 2 is an enlarged cross section of the filter media of the first exemplary embodiment of FIG. 1, showing the manner in which a convoluted sheet of porous filter material forms a common wall separating the first flutes, opening in one direction, from adjacent flutes opening in the opposite direction.

FIG. 3 is an orthographic view of a planar cross section taken along line 3-3 of FIG. 1.

FIG. 4 is a perspective view of a coil of gathered filter media, according to the invention.

FIG. 5 is a perspective view showing a method of constructing the coil of filter material of FIG. 4.

FIG. 6 is a cross section of a second exemplary embodiment of the invention, in the form of a filter apparatus consisting essentially of a filter cartridge, adapted for attachment to a filter assembly, but not including the filter assembly, and having intermediate flow restrictions in neighboring first flutes that are disposed at substantially the same distance from one of the ends of the filter cartridge, in the manner illustrated by the embodiment of FIG. 3.

FIG. 7 is a cross sectional view of a third exemplary embodiment of the invention in the form of a filter apparatus, according to the invention, including a filter assembly and a filter cartridge attached to the filter assembly.

FIG. 8 is a cross sectional view of an exemplary embodiment of the invention, in the form of a filter apparatus which is generally similar to the embodiment of the filter cartridge shown in FIG. 6, except that the intermediate flow restrictions in neighboring first flutes are disposed at varying distances from one of the ends of the filter cartridge.

FIG. 9 is a cross sectional view taken along the line 9-9 in FIG. 3.

FIG. 10 is a cross sectional view taken along the line 10-10 in FIG. 8.

FIG. 11 is a perspective view of an embodiment of the invention having an intermediate flow restriction formed by locally deforming a peak of a convoluted sheet of porous filter material of a fluted filter media.

FIG. 12 is a cross section taken along line 12-12 in FIG. 11, showing an intermediate flow restriction provided by locally deforming a peak of a convoluted sheet of porous filter material, according to the invention.

FIGS. 13 and 14 are cross sections taken along line 12-12 of FIG. 11, showing alternate embodiments of intermediate flow restrictions provided by locally deforming a peak of a convoluted sheet of porous filter material, according to the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

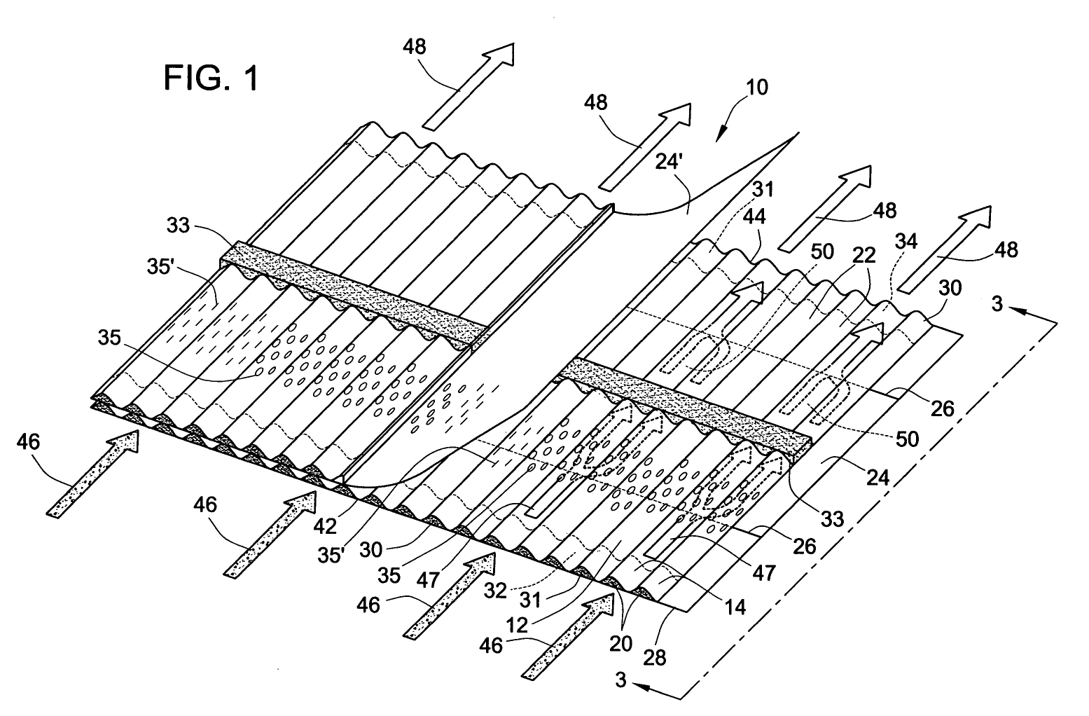

FIG. 1 shows a first exemplary embodiment of the invention in the form of a filter media 10 comprising, a convoluted sheet 12 of porous filter material, for removing particulate matter from a fluid. The term fluid as used herein is intended to include fluids in either liquid or gaseous forms. The exemplary embodiments shown herein specifically illustrate an air filter of the type used for filtering intake air for engines and air compressors. The convoluted sheet may be formed by any appropriate process, such as corrugating or pleating, but preferably by gathering, as described in a United States patent application, entitled “Gathered Filter Media and Method of Making Same,” bearing the attorney docket no. 502854, assigned to the Assignee of the present invention, filed concurrently herewith and incorporated herein by reference.

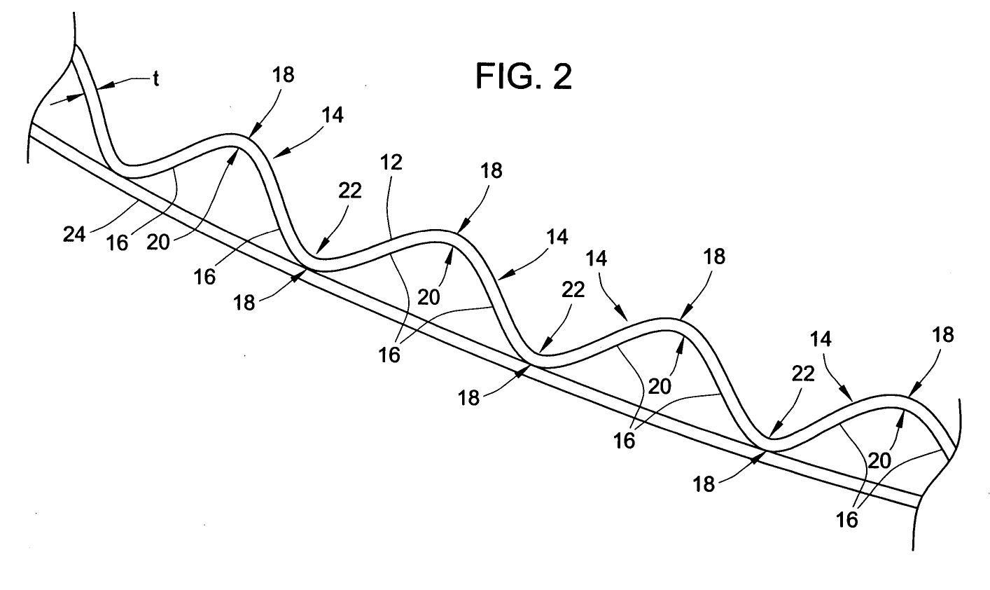

As shown in an enlarged cross section in FIG. 2, the convoluted sheet 12 forms a plurality of contiguous adjacent convolutions 14, each having a generally V-shaped cross section with substantially straight side walls 16 joined by radiused bights 18 to form alternating peaks 20 and valleys 22. In the context of the illustrations and descriptions herein of exemplary embodiments of the invention, the valleys 22 form a plurality of first flutes, hereinafter referred to as first flutes 22, and a plurality of adjacent flutes, hereinafter referred to as adjacent flutes 20

As shown in FIGS. 1 and 2, the filter media 10 of the exemplary embodiment includes a face sheet 24 attached to the convoluted sheet 12, for retaining the convoluted sheet 12 of porous filter material in a convoluted state. The term face sheet, as used herein, is intended to encompass any form of sheet or strip of generally flat material attached to the convoluted sheet 12 of porous filter material. The face sheet 24 may be attached to the convoluted sheet 12 in any appropriate manner, such as by beads of adhesive 26, applied at the juncture of the gathered sheet 12 and the face sheet 24, on the side of the convoluted sheet 12 forming the adjacent flutes 20, i.e. the bottom side of the convoluted sheet 12 as shown in FIG. 1. In the exemplary embodiment of the filter media 10, the face sheet 24 is also a porous filter material. In alternate embodiments of the invention, the face sheet 24 may be non-porous. The face sheet 24 may also include holes 34 or slits 35, as shown in FIG. 1, where either a porous or a non-porous material is used in alternate embodiments, to further facilitate directing a flow of fluid through the media 10 in a desired manner.

The first and adjacent flutes 22, 20 formed by the convolutions 14 of the exemplary embodiment of the filter media 10 are substantially equal in size and equally spaced but, in other embodiments of the invention, this need not necessarily be the case. As shown in FIG. 1, the adjacent flutes 20 of the convolutions 14, proximate to both edges 28, 30 of the filter media 10, have a sealant 31 disposed in them, to thereby form upstream and downstream flow restrictions 32, 34 of the adjacent flutes 20 that block a flow of fluid from entering or exiting the adjacent flutes 20 at either edge 28, 30 of the media 10.

The media 10 also includes an intermediate flow restriction 33 disposed in the first flutes 22 between the first and second ends 28, 30 of the media 10, so that a fluid entering the first flutes upstream of the intermediate flow restriction 33, as shown by arrows 46, is forced to flow through the walls 16 of porous filter material into one or more of the adjacent flutes 20, as shown by arrows 47. Because the downstream ends of the adjacent flutes 20 are blocked along the second edge 30 of the media 10 by the downstream flow restriction 34, in order for the fluid to exit the downstream end of the filter media 10, it must pass through the walls 16 a second time downstream from the intermediate flow restriction 33, as shown by arrows 50, before exiting the downstream ends of the first flutes 22, as shown by arrows 48. In this manner, the fluid is filtered at least twice in traveling from the first to the second edge 28, 30 of the media 10.

Those having skill in the art will recognize that in alternate embodiments of the invention, more than one intermediate flow restriction 33 may be used to cause the fluid to pass through the walls 16 more than two times in traversing the media 10 from the first to the second edge 28, 30, to provide additional filtration. It will also be recognized that the terms first flutes 22 and adjacent flutes 22 are descriptive of the relationship between one another, and that in other embodiments of the invention the adjacent flutes 20 may include intermediate flow restrictions 33 in at least a portion of the adjacent flutes 20, effectively reversing the designation of first and adjacent flutes 22, 20 for that portion of the media. It will be further recognized that in other embodiments of the invention the location of the upstream and downstream flow restrictions 32, 34 of the adjacent flutes 20 may be other than at the edges 28, 30 of the media 10, and/or may not block flow through the upstream or downstream ends of all of the adjacent flutes 20, so that the upstream and or downstream ends of some of the adjacent flutes 20 may be left open. In similar fashion, in some embodiments of the invention the upstream and/or downstream ends of some of the first flutes 22 may be blocked.

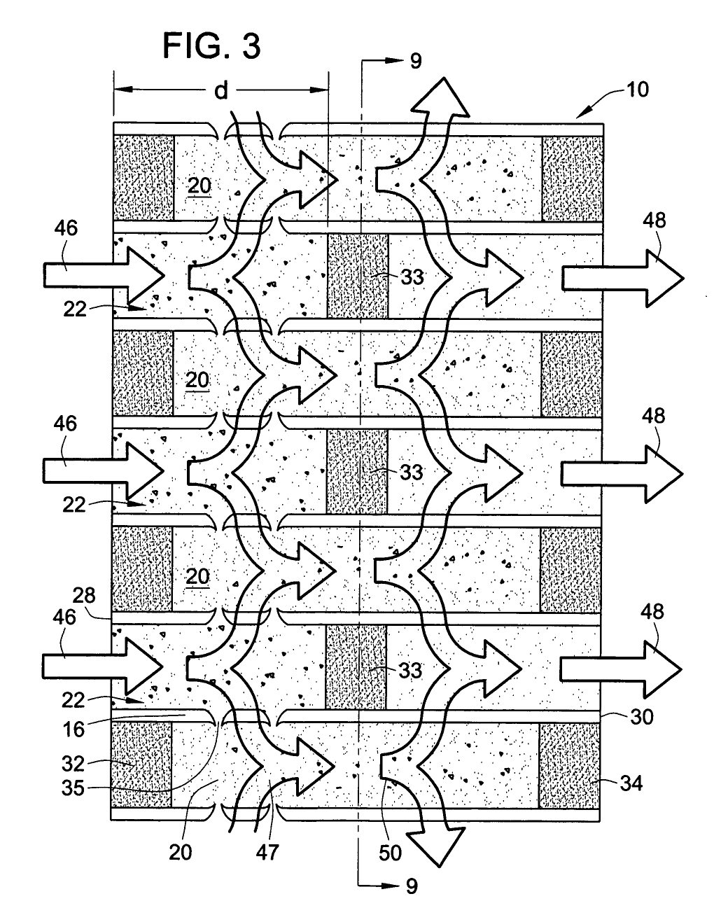

As shown in FIGS. 1 and 3, in some embodiments of the invention, it may be desirable to include one or more openings, in the form of small holes 35 or slits 35′ through the walls 16 of the porous filter material for achieving a desired pressure drop characteristic through the media 10. Such holes and/or slits 35, 35′ may be placed in some or all of the walls 16 between the first and adjacent flutes 22, 20, and be located either upstream and/or downstream from any intermediate flow restrictions 33.

In some embodiments, the walls 16 of porous media, and/or the face sheets 24 may be formed of a porous filter material having a higher porosity section and a lower porosity section, which are selectively positioned for achieving a desired pressure drop characteristic through the media 10. The lower porosity section may be formed, for example by providing a locally thicker wall section, or by adding an additional layer of porous filter material in the areas where lower porosity is desired.

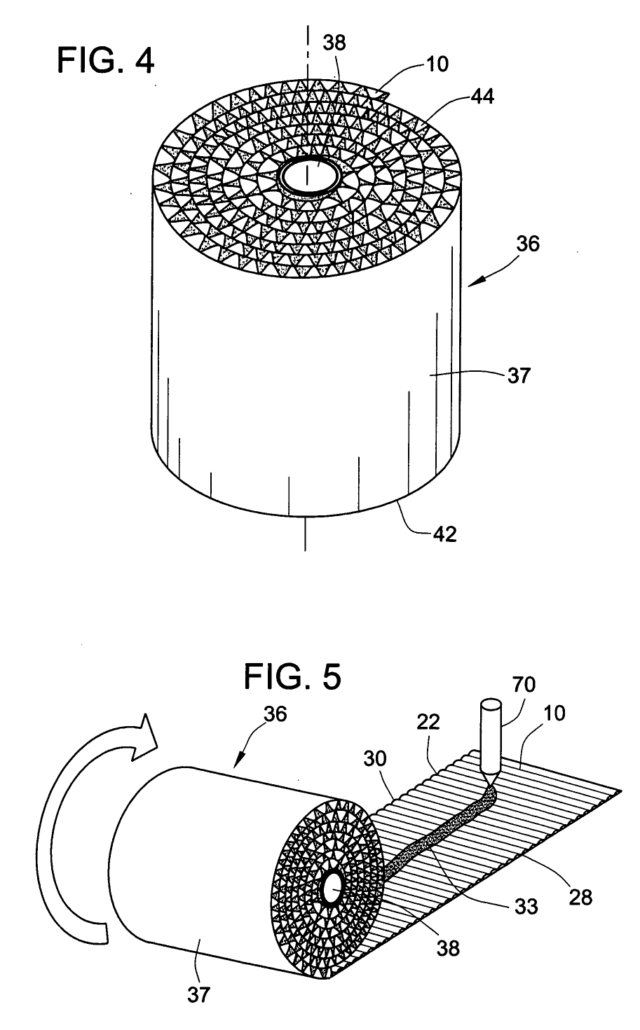

FIGS. 4-6 show a second exemplary embodiment of the invention in the form of a filter cartridge 36, including a coil 37 (FIG. 4) of a convoluted filter media, according to the invention. In the second exemplary embodiment, the filter media shown in FIG. 4 is the convoluted filter media 10, as described above in regard to FIGS. 1-3. In other embodiments of a filter cartridge, according to the invention, however, it will be understood that other forms of a convoluted filter media, according to the invention, could be used. It will also be understood that the convoluted filter media, in other embodiments of filter cartridges according to the invention, need not be coiled, but could be formed in other ways, such as by stacking or otherwise laminating layers of convoluted filter media.

As shown in FIGS. 4-6, the exemplary embodiment of a filter cartridge 36 is formed by winding the convoluted filter media 10 around a central mandrel 38. As shown in FIG. 5, as the convoluted filter media 10 is wound onto the mandrel 38, a bead of sealant is applied in the first flutes 22, to form the intermediate flow restriction 33. As shown in FIG. 1, as the convoluted filter material 10 is coiled, the face sheet 24 is sequentially wrapped over the tops of the adjacent flutes 20 of the previously coiled layer of convoluted filter media 10, the bead of sealant forming the intermediate flow restriction 33 is generally constrained within the first flutes 22 by the face sheet 24′ of the preceding layer of media 10.

By virtue of this construction, one end 42 of the filter cartridge 36 is formed by the first edge 28 of the coiled convoluted filter media 10, and the other end of the filter cartridge 36 is formed by the second edge 30 of the coiled convoluted filter media 10. As a result, at both ends 40, 42 of the filter cartridge 36, the fluid passages formed by the face sheet 24 and the first flutes 22 are open for receiving fluid flow, as shown by inflow arrows 46 in FIG. 1, and the fluid passages formed by the adjacent flutes 20 are blocked at both ends 40, 42 of the filter cartridge 36 by the beads of sealant 31 forming the upstream and downstream flow restrictions 32, 34 in the adjacent flutes 20. As shown by inlet and outlet arrows 46, 48 and crossover arrows 47, 50, in FIGS. 1 and 3, the fluid flow must pass through the walls 16 of the convoluted filter media 10 twice in order to flow through the filter cartridge 36.

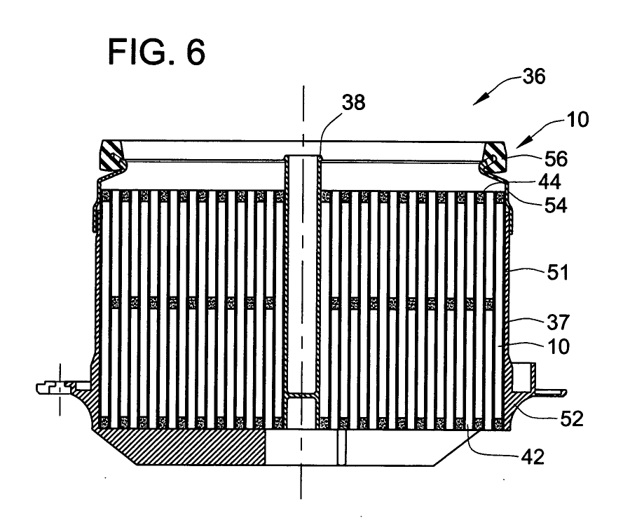

As shown in FIG. 6, the exemplary embodiment of the filter cartridge 36 also includes a frame apparatus 51, circumscribing the filter cartridge 36 and including a bolting ring 52 projecting from one end 42 of the filter cartridge 36. The frame apparatus 51 also includes a support ring 54 extending from the other end 44 of the filter cartridge 36, and supporting a resilient seal 56. The bolting ring 52, seal support ring 54 and resilient seal 56 are provided to adapt the filter cartridge 36 for attachment to a filter assembly.

It will be understood, however, by those having skill in the art, that the first exemplary embodiment of a filter apparatus, according to the invention, in the form of the filter cartridge 36, does not include the filter assembly, but is intentionally limited to a filter apparatus including only a filter cartridge in accordance with the invention, as defined in the appended claims. It will be further understood that, in other embodiments of a filter apparatus comprising only a filter cartridge, according to the invention, the construction of such embodiments of filter cartridges may differ considerably from the exemplary embodiment of the filter cartridge 36 disclosed herein. For example, the cartridge 36 may have other shapes, such as oblong, square, or rectangular. Where a coiled construction is used, the central mandrel 38 may be eliminated, with the winding carried out around a central portion of the convoluted filter media 10, in a manner similar to that used in the past for filters having corrugated filter medias. Many other arrangements may be used, in other embodiments, to adapt the filter cartridge for attachment to the filter assembly.

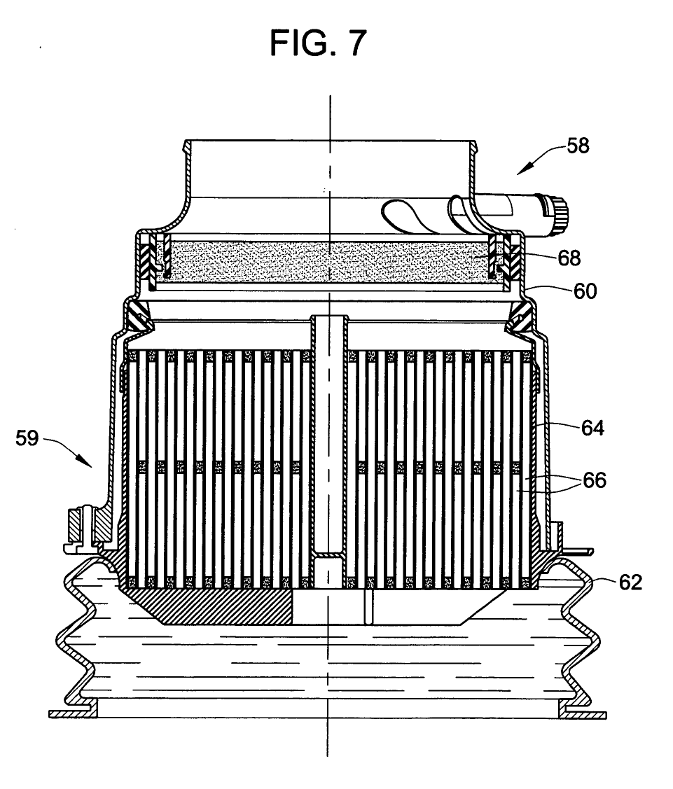

FIG. 7 shows a third exemplary embodiment of the invention, in the form of a filter apparatus 58, including a filter assembly 59, in the form of a filter housing 60 and a boot 62, adapted for attachment thereto of a filter cartridge 64 having one or more layers of a filter media 66 comprising a convoluted sheet of porous filter material. The filter cartridge 64 includes a coiled sheet of convoluted porous filter material, in the same manner as the filter cartridge 36 of the second exemplary embodiment of the invention described above. In contrast to the second exemplary embodiment of the invention, however, in which the filter apparatus included only the filter cartridge 36, and not the filter assembly to which the cartridge is adapted to be attached, the third exemplary embodiment of the invention includes both the filter cartridge 64 and the filter assembly 59 formed by the housing 60 and the boot 62. It should be further noted that the filter apparatus 58 of the third exemplary embodiment also includes a safety filter 68, mounted in the filter housing 60 at a point in the fluid flow path downstream from the filter cartridge 64.

Those having skill in the art will recognize that, although invention has been described herein with reference to several exemplary embodiments, many other embodiments of the invention are possible. For example, the face sheet 24 may be formed from an imperforate and non-porous material instead of the porous filter material described above in relation to the exemplary embodiments. As shown in FIG. 1, the face sheet may also include openings in the form of holes 34 or slits 35, when made from either porous or non-porous materials.

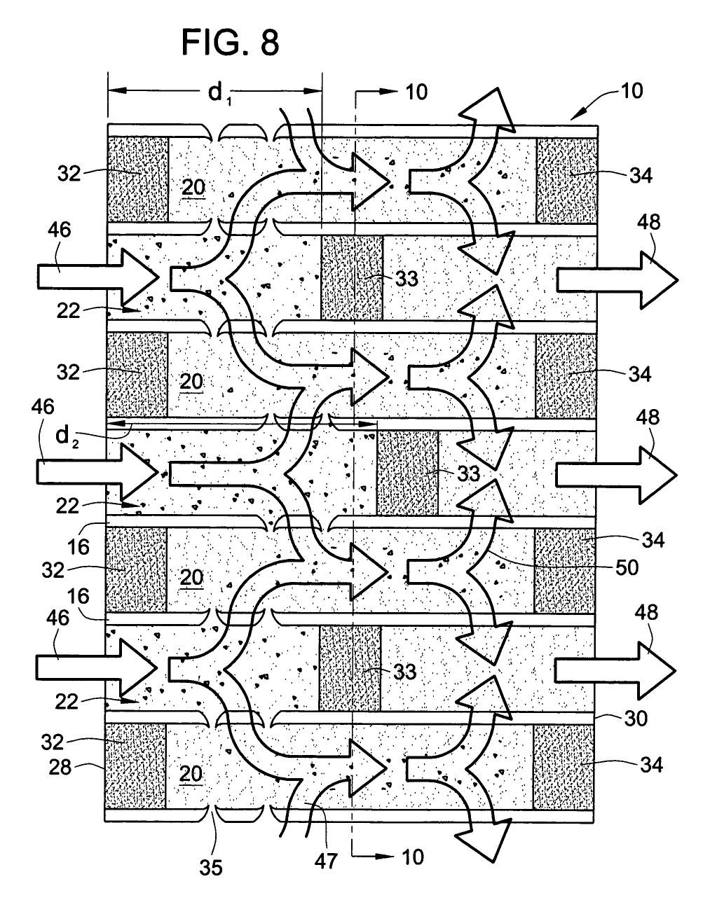

As shown in FIG. 8, the where the media 10 includes a plurality of first flutes 22, each including an intermediate flow restriction 33 therein, the intermediate flow restriction 33 in one or more of the first flutes 22 may disposed at a first distance d₁ from the upstream, as shown, or downstream ends 28, 30 of the media 10, and the intermediate flow restriction 33 in one or more of the other first flutes 22 may be disposed at a second distance d₂ from the one of the upstream, as shown, or downstream ends 28, 30 of the filter media 10.

It may also be advantageous in some embodiments of the invention to have the intermediate flow restrictions 33 in the first flutes 22 offset from one another at distances varying in a predetermined pattern with respect to one of the upstream or downstream ends 28, 30 of the media 10. For example, the intermediate flow restrictions 33 might be applied in a manner forming geometric patterns such as an angled or stepped line, a saw tooth pattern, or a sinusoidal pattern along the length of the media 10. Such embodiments can be relatively easily formed by moving an applicator nozzle 70, applying the sealant that forms the intermediate flow restriction 33, back and forth along the flutes 22 as the media 10 is coiled, as show in FIG. 5.

Such offset arrangements of the intermediate flow restrictions 33 provide advantages in directing fluid flow both within a given layer of the media 10, and between successive layers of the media 10, in ways that are conducive to enhancing filtering efficiency, effectiveness, and contaminant holding capability, and to controlling pressure drop in the media. Within a given layer of a media, according to the invention, offsetting the intermediate flow restrictions 33 in neighboring first flutes 22 causes the flow through the walls 16 of neighboring first flutes 22 into an adjacent flute 20 lying between the neighboring first flutes 22, as shown in FIG. 8, to not be as directly opposing as the flow through the walls 16 of the embodiment shown in FIGS. 1 and 3.

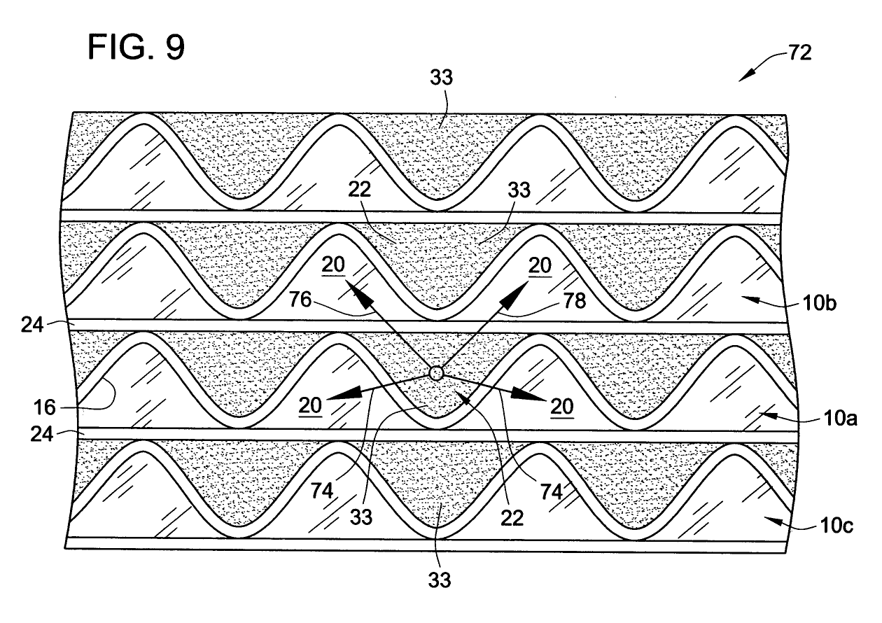

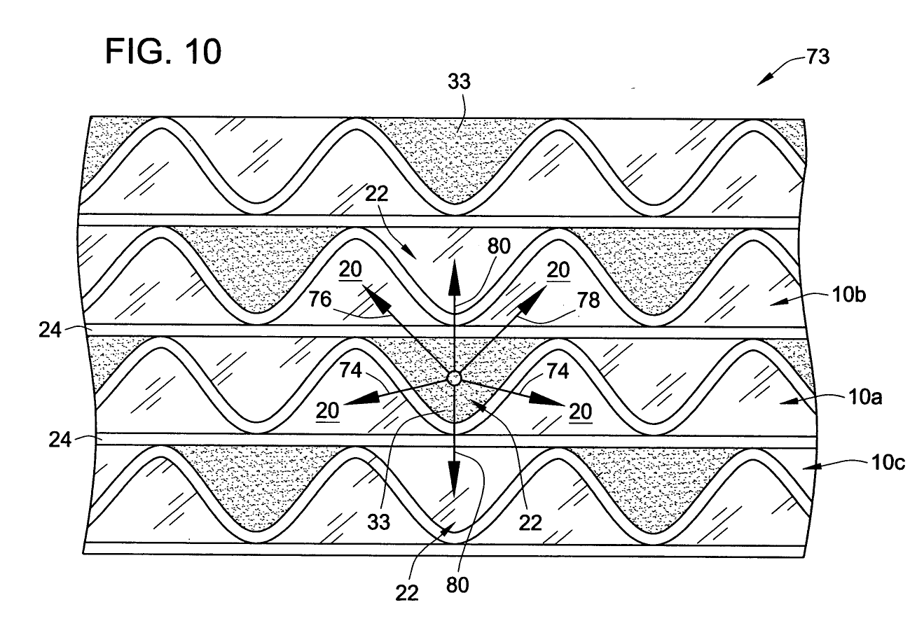

As will be appreciated by comparing FIGS. 9 and 10, having the intermediate flow restrictions 33 offset in successive layers 10A, 10B, 10C of media in an embodiment of a filter apparatus 73, according to the invention, as shown in FIG. 10, can provide a more omni-directional flow of fluid from the first flutes 22 into other flutes 20, as compared to embodiments of a filter apparatus 73 of the invention in which the intermediate flow restrictions 33 are all disposed at substantially the same distance from one of the ends 42, 44 of a filter apparatus 36, as shown in FIG. 9. As illustrated in FIG. 9, in embodiments of a filter apparatus 72, according to the invention, where the intermediate flow restrictions 33 in successive layers 10A, 10B of media are all disposed at substantially the same distance d from one of the ends 28 of the media, fluid in the first flutes 22 of one of the layers 10A of media cannot flow into a first flute 22 of a successive layer 10B, 10C of media. As shown by arrows 74, in FIG. 9, flow from a given first flute 22 in a given layer 10A is generally constrained to flow horizontally within that layer 10A into adjacent flutes 20 lying on either side of the given first flute 22 within the given layer 10A. This is particularly true where the face sheets 24 between the given and adjacent layers 10A, 10B, 10C, is non-porous and imperforate. Even where the face sheets 24 are formed of a porous or perforate material, flow is still restricted to the adjacent flutes 20 lying on either side of a given first flute 22 within the given layer 10A, and to the adjacent flutes 20 of one adjacent layer 10B, as shown by oblique arrows 76, 78 in FIG. 9.

As shown in FIG. 10, when the intermediate flow restrictions 33 offset in successive layers 10A, 10B, 10C, of a filter apparatus 72, with the successive layers separated by porous or perforated face sheets 24, according to the invention, the fluid in a given first flute 22 can also flow in a vertical direction, as shown by arrows 80 in FIG. 10, into the first flutes 22 of the neighboring successive layers 10B, 10C of the filter apparatus 72. With such an arrangement, it will be understood that the first flutes 22 in successive layers effectively function for a portion of their length as additional “adjacent flutes” for the given first flute 22. In this manner, the flow distribution within the filter apparatus 73 can be advantageously directed to provide enhanced performance.

While it will be understood by those having skill in the art that in many embodiments of the invention the intermediate flow restrictions 33 in successive layers 10A, 10B, 10C will not be in perfect vertical alignment, as shown schematically in FIG. 9, due to coiling of the media 10 for example, having the intermediate flow restrictions 33 disposed at varying distances from one of the ends 28, 30 of the media 10 will still result in improved flow between successive layers 10A, 10B, 10C of a filter apparatus, according to the invention, as compared to embodiments of the invention in which the intermediate flow restrictions 33 are all disposed at substantially the same distance from one of the edges 28, 30 of the media 10.

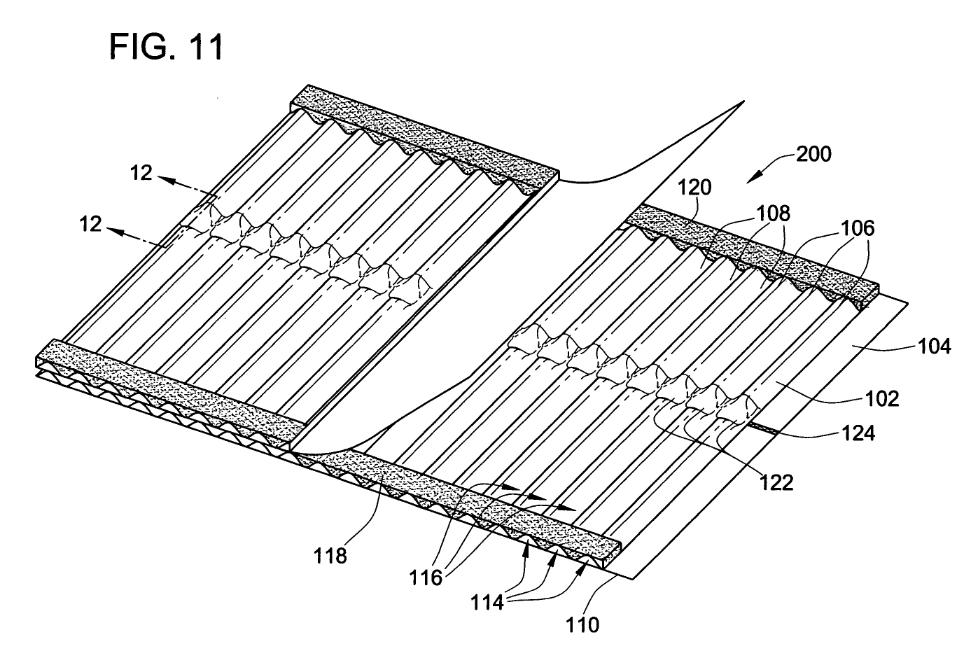

FIG. 11 illustrates an alternate embodiment of the invention in the form of a media 100 including a convoluted sheet 102 of porous material attached to a face sheet 104. The convoluted sheet 102 has a plurality of peaks 106 and valleys 108 extending in a generally parallel and adjacent orientation to one another from an upstream end 110 to a downstream end 112 of the filter media 100, with the peaks and valleys 106, 108 at least partially defining a plurality of first flutes 114, alternating with a plurality of adjacent flutes 116. The adjacent flutes 116 each include an upstream and a downstream flow restriction 118, 120, formed by solid beads of sealant, such that the upstream and downstream ends 110, 112 of the adjacent flutes 116 are completely blocked against receiving or discharging fluid. Portions of the peaks 106 are locally deformed to provide an intermediate flow restriction 122 in each of the first flutes 114.

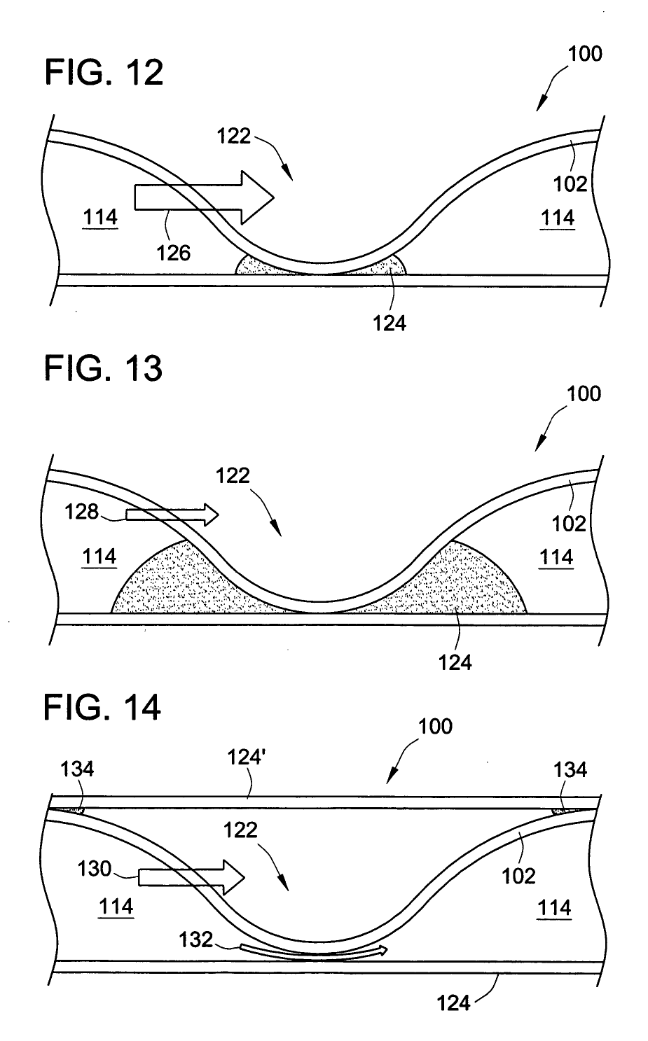

As shown in FIGS. 11 and 12, the intermediate flow restrictions 122 of the media 100 may be attached to the face sheet 104 by a small bead of adhesive or sealant 124, so that a first portion of the fluid flowing through the first flutes 114 may still flow through the convoluted sheet 102 in a direction generally parallel to the centerline of the first flutes 104, in the manner indicated by arrow 126 in FIG. 12, while a second portion of the fluid flowing in the first flutes 114 is urged to pass through the wall of porous material into an adjacent flute 116. As shown by arrow 128 in FIG. 13, the volume of fluid in the first portion of fluid, allowed to flow along the centerline of the first flutes 114, can be selectively adjusted during manufacture of the media 100 by controlling the size of the bead of adhesive or sealant 124, so that more or less of the wall of the convoluted sheet 102 in the locally deformed area comprising the intermediate flow restriction 122 is left exposed to the fluid in the first flutes 114.

Alternatively, as shown in FIG. 14, in some embodiments of the invention it may be desirable to not attach the intermediate flow restriction 122 to the face sheet 24, in the manner described above in relation to the embodiments of FIGS. 12 and 13, so that a first portion of the fluid flowing in the first flutes may flow along the centerline of the first flutes through the wall of the convoluted sheet 102, as illustrated by arrow 130, and also between the convoluted sheet 102 and the face sheet 124, as illustrated by arrow 132. In such an arrangement, it may be desirable to attach the peaks 106 of the convoluted sheet 102 to the face sheet 124′ of an adjacent layer of the media, with beads of adhesive or sealant 134, as shown in FIG. 14, on either side of the intermediate flow restriction 122, to help hold the shape of the intermediate flow restriction 122. The volume of flow between the convoluted sheet 102 and the face sheet 124 (illustrated by arrow 132) can be controlled by controlling the space left between the locally deformed section of the convoluted sheet 102 and the face sheet 124 during manufacture of the media 100.

It will also be understood, that although the intermediate flow restriction was generally shown as being placed approximately half-way between the upstream and downstream ends of the media in the exemplary embodiments described above, the intermediate flow restriction need not be located in this manner in other embodiments of the invention. In other embodiments, it may be desirable to locate the intermediate flow restriction closer to either the upstream or downstream ends of the media to achieve a desired pressure drop characteristic or distribution of flow through the media, or to enhance other properties such as the contaminant holding capability of the media.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter media defining an upstream and a downstream end thereof, a first flute and one or more adjacent flutes extending from the upstream end to the downstream end of the filter media and including upstream and downstream ends of the first and adjacent flutes at the upstream and downstream ends respectively of the filter media, the filter media further comprising:
a wall of porous filter material separating the first flute from the one or more adjacent flutes;
an intermediate flow restriction disposed in the first flute between the upstream and downstream ends of the filter media, whereby a portion of a flow of fluid entering the first flute upstream of the intermediate flow restriction is urged to flow through the wall upstream of the intermediate flow restriction into at least one adjacent flute in order to flow from the upstream end to the downstream end of the filter media;
an upstream flow restriction disposed in the at least one adjacent flute upstream from the intermediate flow restriction; and
a downstream flow restriction disposed in the at least one adjacent flute at a point downstream from the intermediate flow restriction for urging fluid in the at least one adjacent flute to flow through the wall into the first flute downstream from the intermediate flow restriction.

2. The filter media of claim 1, wherein the media includes a plurality of first flutes each including an intermediate flow restriction therein disposed at substantially the same distance from one of the upstream or downstream ends of the media.

3. The filter media of claim 1, wherein the media includes a plurality of first flutes each including an intermediate flow restriction therein, with the intermediate flow restriction in one or more of the first flutes of the plurality of first flutes being disposed at a first distance from one of the upstream or downstream ends of the media, and the intermediate flow restriction in one or more of the other first flutes of the plurality of first flutes being disposed at a second distance from the one of the upstream or downstream ends of the media.

4. The filter media of claim 1, wherein the media includes a plurality of first flutes each including an intermediate flow restriction therein, and the intermediate flow restrictions are disposed within their respective first flutes at distances varying in a predetermined pattern with respect to one of the upstream or downstream ends of the media.

5. The filter media of claim 1, wherein the downstream flow restriction is disposed proximate the downstream end of the at least one adjacent flute.

6. The filter media of claim 5, wherein the upstream flow restriction is disposed proximate the upstream end of the at least one adjacent flute.

7. The filter media of claim 1, wherein the upstream flow restriction is disposed proximate the upstream end of the adjacent flute.

8. The filter media of claim 1, wherein at least one of the upstream and downstream ends of the first flute are open for allowing a flow of fluid therethrough.

9. The filter media of claim 1, wherein both the upstream and downstream ends of the first flute are open.

10. The filter media of claim 1, wherein the wall includes a higher porosity section thereof and a lower porosity section thereof

11. The filter media of claim 10, wherein the higher porosity section of the wall is disposed upstream from the intermediate flow restriction, and the lower porosity section is disposed downstream from the intermediate flow restriction.

12. The filter media of claim 1, wherein the wall includes one or more openings therein providing fluid communication between the first flute and at least one of the one or more adjacent flutes.

13. The filter media of claim 12, wherein the one or more openings are disposed between the upstream end of the first flute and the intermediate flow restriction.

14. The filter media of claim 1, wherein the wall of porous material includes a convoluted sheet of the porous filter material having peaks and valleys extending in a generally parallel and adjacent orientation to one another from the upstream to the downstream end of the filter media, with the convolutions at least partially defining the first flute, and at least one of the one or more adjacent flutes.

15. The filter media of claim 14, further comprising a face sheet attached to the convoluted sheet.

16. The filter media of claim 15, wherein the face sheet defines one or more openings therethrough.

17. The filter media of claim 15, wherein the face sheet of the filter media comprises a porous filter material at least partially forming the wall.

18. The filter media of claim 17, wherein the face sheet includes a higher porosity section thereof and a lower porosity section thereof

19. The filter media of claim 18, wherein the higher porosity section of the face sheet is disposed upstream from the intermediate flow restriction, and the lower porosity section is disposed downstream from the intermediate flow restriction.

20. The filter media of claim 14, wherein the intermediate flow restriction in at least one of the flutes comprises a deformed section of one or more of the peaks of the convoluted sheet.

21. A method for forming a filter media defining an upstream and a downstream end thereof, the method comprising:
forming a first flute and one or more adjacent flutes, extending from the upstream end to the downstream end of the filter media and having respective upstream and downstream ends of the first and adjacent flutes, with the first flute being separated from at least one of the one of more adjacent flutes by a wall of porous filter material;
disposing an intermediate flow restriction in the first flute between the upstream and downstream ends of the filter media in such a manner that a fluid entering the first flute upstream of the intermediate flow restiction is urged to flow through the wall upstream of the intermediate flow restriction into at least one of the one or more adjacent flutes in order to flow from the upstream end to the downstream end of the filter media;
disposing an upstream flow restriction in the at least one adjacent flute upstream from the intermediate flow restriction; and
disposing a downstream flow restriction in the at least one adjacent flute at a point downstream from the intermediate flow restriction for urging fluid in the at least one adjacent flute to flow through the wall into the first flute downstream from the intermediate flow restriction.

22. The method of claim 21, further comprising forming a plurality of first flutes each including an intermediate flow restriction therein, with the intermediate flow restriction in each of the plurality of first flutes being disposed at substantially the same distance from one of the upstream or downstream ends of the media.

23. The method of claim 21, further comprising forming a plurality of first flutes each including an intermediate flow restriction therein, with the intermediate flow restriction in one or more of the first flutes of the plurality of first flutes being disposed at a first distance from one of the upstream or downstream ends of the media, and the intermediate flow restriction in one or more of the other first flutes of the plurality of first flutes being disposed at a second distance from the one of the upstream or downstream ends of the media.

24. The method of claim 21, further comprising forming a plurality of first flutes each including an intermediate flow restriction therein, with the intermediate flow restrictions being disposed within their respective first flutes at distances varying in a predetermined pattern with respect to one of the upstream or downstream ends of the media.

25. The method of claim 21, further comprising positioning the intermediate flow restriction within the first flute, between the first and second ends of the first flute, to provide a desired flow resistance for a flow of fluid passing through at least a portion of the first flute from the upstream end to the downstream end of the filter media.

26. The method of claim 21, further comprising forming one or more openings extending through the wall, with the openings providing fluid communication between the first flute and at least one of the one or more adjacent flutes.

27. The method of claim 26, further comprising positioning the openings in the wall to provide a desired flow resistance for a flow of fluid passing through at least a portion of the first flute from the upstream end to the downstream end of the filter media.

28. The method of claim 21, further comprising forming at least a section of the wall from a porous filter material having a higher porosity section and a lower porosity section.

29. The method of claim 28, further comprising disposing the higher and lower porosity sections within the wall of porous material to provide a desired flow resistance to a flow of fluid passing from the upstream to the downstream ends of the media.

30. A filter apparatus comprising:
two or more layers of a filter media defining an upstream and a downstream end of the filter media, a first flute and one or more adjacent flutes extending from the upstream end to the downstream end of the filter media and including upstream and downstream ends of the first and adjacent flutes at the upstream and downstream ends respectively of the filter media, with the two or more layers of filter media each having a wall of porous filter material separating the first flute from the one or more adjacent flutes;
an intermediate flow restriction disposed in the first flute between the upstream and downstream ends of the filter media, whereby a portion of a flow of fluid entering the first flute upstream of the intermediate flow restriction is urged to flow through the wall upstream of the intermediate flow restriction into at least one adjacent flute in order to flow from the upstream end to the downstream end of the filter media;
an upstream flow restriction disposed in the at least one adjacent flute upstream from the intermediate flow restriction; and
a downstream flow restriction disposed in the at least one adjacent flute at a point downstream from the intermediate flow restriction for urging fluid in the at least one adjacent flute to flow through the wall into the first flute downstream from the intermediate flow restriction.

31. The filter apparatus of claim 30, wherein the media includes a plurality of first flutes each including an intermediate flow restriction therein disposed at substantially the same distance from one of the upstream or downstream ends of the media.

32. The filter apparatus of claim 30, wherein the media includes a plurality of first flutes each including an intermediate flow restriction therein, with the intermediate flow restriction in one or more of the first flutes of the plurality of first flutes being disposed at a first distance from one of the upstream or downstream ends of the media, and the intermediate flow restriction in one or more of the other first flutes of the plurality of first flutes being disposed at a second distance from the one of the upstream or downstream ends of the media.

33. The filter apparatus of claim 30, wherein the media includes a plurality of first flutes each including an intermediate flow restriction therein, and the intermediate flow restrictions are disposed within their respective first flutes at distances varying in a predetermined pattern with respect to one of the upstream or downstream ends of the media.

34. The filter apparatus of claim 30, wherein the downstream flow restriction is disposed proximate the downstream end of the at least one adjacent flute.

35. The filter apparatus of claim 34, wherein the upstream flow restriction is disposed proximate the upstream end of the at least one adjacent flute.

36. The filter apparatus of claim 30, wherein the upstream flow restriction is disposed proximate the upstream end of the adjacent flute.

37. The filter apparatus of claim 30, wherein at least one of the upstream and downstream ends of the first flute are open for allowing a flow of fluid therethrough.

38. The filter apparatus of claim 30, wherein both the upstream and downstream ends of the first flute are open.

39. The filter apparatus of claim 30, wherein the wall includes a higher porosity section thereof and a lower porosity section thereof

40. The filter apparatus of claim 39, wherein the higher porosity section of the wall is disposed upstream from the intermediate flow restriction, and the lower porosity section is disposed downstream from the intermediate flow restriction.

41. The filter apparatus of claim 30, wherein the wall includes one or more openings therein providing fluid communication between the first flute and at least one of the one or more adjacent flutes.

42. The filter media of claim 41, wherein the one or more openings are disposed between the upstream end of the first flute and the intermediate flow restriction.

43. The filter apparatus of claim 30, wherein the wall of porous material includes a convoluted sheet of the porous filter material having peaks and valleys extending in a generally parallel and adjacent orientation to one another from the upstream to the downstream end of the filter media, with the convolutions at least partially defining the first flute, and at least one of the one or more adjacent flutes.

44. The filter apparatus of claim 43, further comprising a face sheet attached to the convoluted sheet.

45. The filter apparatus of claim 44, wherein the face sheet defines one or more openings therethrough.

46. The filter apparatus of claim 45, wherein the face sheet of the filter media comprises a porous filter material at least partially forming the wall.

47. The filter apparatus of claim 46, wherein the face sheet includes a higher porosity section thereof and a lower porosity section thereof

48. The filter apparatus of claim 47, wherein the higher porosity section of the face sheet is disposed upstream from the intermediate flow restriction, and the lower porosity section is disposed downstream from the intermediate flow restriction.

49. The filter apparatus of claim 43, wherein the intermediate flow restriction in at least one of the flutes comprises a deformed section of one or more of the peaks of the convoluted sheet.

50. The filter apparatus of claim 44 wherein the face sheet defines openings therethrough, for providing fluid communication between the first flute in one of the two or more layers of the filter media and at least one first flute or adjacent flute in another of the two or more layers of the filter media.

51. The filter media of claim 30, wherein the wall includes openings therethrough providing fluid communication between the first flute in one of the two or more layers of the filter media and at least one first flute or adjacent flute in another of the two or more layers of the filter media.

52. The filter apparatus of claim 44 wherein the face sheet defines openings therethrough, for providing fluid communication between the first flute in one of the two or more layers of the filter media and at least one first flute or adjacent flute in another of the two or more layers of the filter media.

53. The filter apparatus of claim 30, wherein the filter apparatus comprises a filter cartridge, adapted for attachment to a filter assembly, but not including the filter assembly.

54. The filter apparatus of claim 30, wherein the filter apparatus comprises a filter assembly adapted for attachment thereto of a filter cartridge, and a filter cartridge including two or more layers of the filter media.

55. A method for filtering a flow of fluid with filter media defining an upstream and a downstream end thereof, a first flute and one or more adjacent flutes, with the first and adjacent flutes extending from the upstream end to the downstream end of the filter media and having respective upstream and downstream ends of the first and adjacent flutes and having the first flute separated from at least one of the one of more adjacent flutes by a wall of porous filter material, the method comprising:
disposing an intermediate flow restriction in the first flute between the upstream and downstream ends of the filter media in such a manner that fluid entering the first flute upstream of the intermediate flow restriction is urged to flow through the wall upstream of the intermediate flow restriction into at least adjacent flute in order to flow from the upstream end to the downstream end of the filter media;
disposing an upstream flow restriction in the at least one adjacent flute upstream from the intermediate flow restriction; and
directing a portion of the flow of fluid into the upstream end of the first flute.

56. The method of claim 55, further comprising disposing a downstream flow restriction in the at least one adjacent flute at a point downstream from the intermediate flow restriction for urging fluid in the at least one adjacent flute to flow through the wall into the first flute downstream from the intermediate flow restriction

57. The method of claim 55, wherein the media includes a plurality of first flutes, and the method further comprises:
disposing an intermediate flow restriction in each of the first flutes of the plurality of first flutes;
forming a filter apparatus having two or more layers of the media including a plurality of first flutes each including an intermediate flow restriction therein, with the upstream and downstream ends respectively of the two or more layers of media extending between upstream and downstream ends thereof; and
directing the flow of fluid into the upstream ends of the filter apparatus.

58. The method of claim 57, further comprising disposing the intermediate flow restrictions within their respective first flutes at various distances from the upstream ends of the media.

59. The method of claim 55, further comprising positioning the intermediate flow restrictions within the first flute, between the first and second ends of the first flute, to provide a desired flow resistance for the portion of the flow of fluid in at least a portion of the first flute.

60. The method of claim 55, further comprising forming one or more openings extending through the wall, with the openings providing fluid communication between the first flute and at least one of the one or more adjacent flutes.

61. The method of claim 60, further comprising positioning the openings in the wall to provide a desired flow resistance for a portion of the flow of fluid passing through at least a portion of the first flute.

62. The method of claim 55, further comprising providing sections of higher and lower porosity in the wall of porous filter material, and disposing the sections of higher and lower porosity in a predetermined location within the wall of porous material.
